(19) United States
(12) Patent Application Publication
(10) Pub. No.: US 2005/0093966 A1
(43) Pub. Date: May 5, 2005

(54) Multibeam light source unit, laser scanning apparatus having the same and method for assembling the laser scanning apparatus

(76) Inventor: Tae-kyoung Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/827,422

(22) Filed: Apr. 20, 2004

(30) Foreign Application Priority Data
Nov. 1, 2003 (KR) 2003-77136

(51) Int. Cl. B41J 2/45

(52) U.S. Cl. 347/238

(57) ABSTRACT

A multibeam laser scanning apparatus which can easily align the positions of a plurality of laser beams, thus improving workability and productivity. The multibeam laser scanning apparatus comprises a multibeam light source unit which has a diode unit including a laser diode emitting a plurality of laser beams, a rotating member for supporting the diode unit, and a fixing member for rotatably supporting the rotating member. The rotating member is turned at a predetermined angle to align the positions of the plurality of laser beams and is fixed to the fixing member. The positions of laser beams are aligned in a sub-assembly line for assembling the multibeam light source unit. The assembled multibeam light source unit is simply mounted into a frame in the main assembly line for completing the assembly of a laser scanning apparatus.

### CROSS-REFERENCE TO RELATED APPLICATIONS

This application claims the benefit of Korean Patent Application No. 2003-77136 filed Nov. 1, 2003, in the Korean Intellectual Property Office, the entire contents of which are incorporated herein by reference.

### BACKGROUND OF THE INVENTION

1. Field of the Invention:

The present invention relates to a laser scanning apparatus used for an image forming apparatus, such as a laser beam printer or a digital copying machine. More particularly, the present invention relates to an improved multibeam light source unit for forming a multibeam laser scanning apparatus which simultaneously writes multiple lines using multiple laser beams, a laser scanning apparatus having the multibeam light source unit, and a method for assembling the laser scanning apparatus.

1. Description of the Related Art:

Recent developments in the industry have produced a multibeam laser scanning apparatus which can simultaneously write multiple lines using multiple laser beams in an electrophotographic image forming apparatus. One example of such an electrophotographic image forming apparatus is a laser beam printer.

The multibeam laser scanning apparatus simultaneously scans a plurality of laser beams spaced from each another. As shown in FIG. 1, a multibeam laser scanning apparatus includes a multibeam light source unit 10, a cylindrical lens 20, a polygon mirror 30, an image resulting lens 40, a detection mirror 51, an optical sensor 52 for detecting a synchronizing signal, and a frame 60 for containing and supporting the above components.

The multibeam light source unit 10 includes a laser diode 11 for projecting at least two laser beams PI and P2, a diode holder 12 for fixing the laser diode 11, a driving circuit board 13 for controlling the driving of the laser diode 11, a collimating lens 14 for transforming multiple laser beams projected from the laser diode 11 into parallel rays of light, and a lens holder 15 connected to the diode holder 12 to support the collimating lens 14.

The two laser beams P1 and P2 projected from the laser diode 11 are collimated to be parallel to each other by the collimating lens 14, and are focused on the reflection plane of the polygon mirror 30 through the cylindrical lens 20. The laser beams are then led to the surface of a photoreceptor of a rotating drum (not shown) by way of the image resulting lens 40 to form an image.

The cylindrical lens 20 concentrates the laser beams P1 and P2 linearly onto the reflection plane of the polygon mirror 30, thus preventing point images formed on the photoreceptor of the rotating drum from being distorted due to the surface inclination of the polygon mirror 30. The image resulting lens 40 consist of a spherical lens and a toric lens. A toric lens has one of its surfaces shaped like part of a torus so that its focal lengths are different in different meridians. Like the cylindrical lens 20, the image resulting lens 40 prevents distortion of point images on the photoreceptor. The image resulting lens 40 has the additional function for correcting any image distortion so that point images can be scanned across the photoreceptor in the main-scanning direction at a constant velocity.

The two laser beams P1 and P2 are split at the end of the main-scanning plane by the detection mirror 51 and introduced to the optical sensor 52 positioned at the opposite side. The laser beams are converted into a writing commencement signal by a controller (not shown) and transmitted to the laser diode 11. Upon receiving the signal, the laser diode 11 modulates the writing of the laser beams P1 and P2. The laser diode 11 can control the starting point of writing an electrostatic latent image formed on the photoreceptor of the rotating drum by controlling the writing modulation time for the laser beams P1 and P2.

The cylindrical lens 20, polygon mirror 30, image resulting lens 40 are fixed onto the bottom of the frame 60. The frame 60 encompassing each optical component is closed by a cover (not shown).

As shown in FIG. 2, the multibeam light source unit 10 is fixed to a side wall 60a of the frame 60.

To mount the multibeam light source unit 10, the diode holder 12 is first inserted into an opening 60b formed on the side wall 60a. After the optical axis and focus of the collimating lens 14 are adjusted, the lens holder 15 is affixed to the diode holder 12.

The vertical and horizontal positions of the laser beams P1 and P2 are adjusted by turning the multibeam light source unit 10 at a predetermined angle θ around the optical axis. Next, the diode holder 12 is affixed to the side wall 60a of the frame 60 using a screw 61.

In a general multibeam laser scanning apparatus having the above structure, the multibeam light source unit 10 is provisionally assembled onto the side wall 60a of the frame 60 and turned at a predetermined angle using a large laser beam position alignment jig in order to align the vertical and horizontal positions of laser beams. During the laser scanning apparatus assembly process in the main assembly line, the position alignment of laser beams is performed before completely fixing the multibeam light source unit 10 to the frame 60. The additional process of position alignment of the laser beam in the main assembly line, however, reduces workability and productivity.

Also, it is additionally required to provide a device for aligning the vertical and horizontal positions of laser beams emitted from the multibeam light source unit 10. For example, a laser beam position alignment jig must be provided of a size large enough to carry the laser scanning apparatus on the laser beam position alignment jig.

### SUMMARY OF THE INVENTION

The present invention has been made to solve the above-mentioned problems occurring in the prior art, and an aspect of the present invention is to provide an improved multibeam light source unit capable of aligning positions of laser beams in a sub-assembly line for assembling the unit.

Another aspect of the present invention is to provide a multibeam laser scanning apparatus comprising a multibeam light source unit which can easily align positions of a plurality of laser beams, thus improving workability and productivity, and a method for assembling the apparatus.

To accomplish the above aspects, there is provided a multibeam light source unit comprising a diode unit having a laser diode for emitting a plurality of laser beams, a rotating member for supporting the laser diode, and a fixing member for rotatably supporting the rotating member. The rotating member is turned at an angle selected to align the positions of the plurality of laser beams and is fixed to the fixing member.

The rotating member comprises a press fit hole into which the laser diode is press-fitted and a rotating boss as a center of rotation. The fixing member comprises a first member having a boss hole into which the rotating boss is rotatably inserted and a second member vertically extending from the first member.

The multibeam light source unit comprises a pair of screws for fixing the rotating member which has been turned to align the positions of laser beams to the first member of the fixing member. In this connection, the rotating member further comprises a pair of circular arc-shaped long holes into which the pair of screws can be engaged.

The rotating member further comprises a gear section at one side. The gear section is engaged with a rotary gear of a laser beam position alignment jig which is provided to turn the rotating member. With the rotation of the rotary gear, the rotating member can be turned easily and exactly at a predetermined angle.

Two gear sections at two opposite sides of the rotating member can be provided. At this time, the laser beam position alignment jig can have two rotary gears to be engaged with the two corresponding gear sections. This structure eliminates backlash and enables more accurate control of the turning angle of the rotating member.

The diode unit comprises a driving circuit board for controlling the driving of the laser diode. The driving circuit board is connected to the rotating member by a fastening means, such as a screw.

The multibeam light source unit according to a certain embodiment of the present invention further comprises a collimating lens for transforming a plurality of laser beams emitted from the laser diode into parallel rays of light and a lens holder for supporting the collimating lens. The lens holder is placed within the second member of the fixing member.

The second member comprises, at the center, a semi-circular groove in which the lens holder is placed, and a plurality of holes is formed at both sides of the semi-circular groove so that the second member can be fixed to an object by use of any fastening means penetrating the holes. “Object” refers to a frame having a bottom and side walls and receiving each component of the laser scanning apparatus.

In accordance with another aspect of the present invention, there is provided a multibeam laser scanning apparatus comprising a multibeam light source unit for emitting a plurality of laser beams a scanning/image resulting unit for scanning a plurality of laser beams and forming an image on the scanning plane, and a frame for supporting the multibeam light source unit and the scanning/image resulting unit. The multibeam light source unit further comprises a laser diode having at least two laser beam projecting sections, a driving circuit board for controlling the driving of the laser diode, a rotating member for supporting the laser diode and the driving circuit board, and a fixing member for rotatably supporting the rotating member. The rotating member is turned at a predetermined angle to align the positions of the two laser beams and is fixed to the fixing member.

The multibeam light source unit is mounted and fixed onto the bottom of the frame.

The scan imaging unit comprises a polygon mirror for scanning the plurality of laser beams projected from the multibeam light source unit and an image resulting lens for imaging the laser beams scanned by the polygon mirror on the scanning plane. The laser scanning apparatus comprises a cylindrical lens for linearly concentrating the plurality of laser beams onto the reflection plane of the polygon mirror and a synchronizing signal detection unit.

To fabricate such a multibeam laser scanning apparatus, there is provided a method comprising assembling a multibeam light source unit including a laser diode for emitting a plurality of laser beams in a sub-assembly line and mounting the multibeam light source unit into a frame in a main assembly line. The step of assembling the multibeam light source unit in the sub-assembly line comprises turning the laser diode at a predetermined angle to align the positions of the plurality of laser beams emitted from the laser diode.

The multibeam light source unit comprises a rotating member for supporting the laser diode and a fixing member for rotatably supporting the rotating member. The rotating member is turned at a predetermined angle using a laser beam position alignment jig to align the position of the laser diode, with the fixing member being fixed to the alignment jig.

The rotating member comprises a gear section formed at one side of the periphery thereof. The laser beam position alignment jig has a fixing section for fixing the fixing member of the multibeam light source unit and a rotary gear engaged with a gear section of the rotating member. The rotating member is turned at a predetermined angle with the rotation of the rotary section. Two gear sections can be formed at both sides of the rotating member. The laser beam position alignment jig preferably has two rotary gears to be engaged with the two corresponding gear sections.

According to the certain embodiment of the present invention, the position alignment of laser beams is performed in the sub-assembly line for assembling the multibeam light source unit, and the assembled multibeam light source unit is mounted into the frame in the main assembly line. Therefore, the various embodiments of the present invention can simplify and minimize the main assembly line, and enables easy and accurate alignment of the laser beam positions.

### BRIEF DESCRIPTION OF THE DRAWING FIGURES

The above aspects and other advantages of the present invention will be more apparent from the following detailed description taken in conjunction with the accompanying drawing figures, in which:

FIG. 1 is a plan view illustrating a conventional multibeam laser scanning apparatus;

FIG. 2 is a perspective view illustrating a light source unit turned and fixed to the multibeam laser scanning apparatus in FIG. 1;

FIGS. 3A and 3B are an exploded view and an assembly view illustrating a multibeam light source unit according to an embodiment of the present invention;

FIG. 4 is a plan view illustrating a rotating member that is part of the multibeam light source unit according to an embodiment of the present invention;

FIG. 5 is a plan view illustrating another example of a rotating member that is part of the multibeam light source unit according to an embodiment of the present invention;

FIGS. 6A and 6B illustrate the position alignment of laser beams in the multibeam light source unit having the rotating member of FIG. 5;

FIG. 7 is a plan view illustrating still another example of a rotating member that is part of the multibeam light source unit according to an embodiment of the present invention; and

FIG. 8 is a plan view illustrating an example of a laser scanning apparatus having the multibeam light source unit according to the certain embodiment of the present invention.

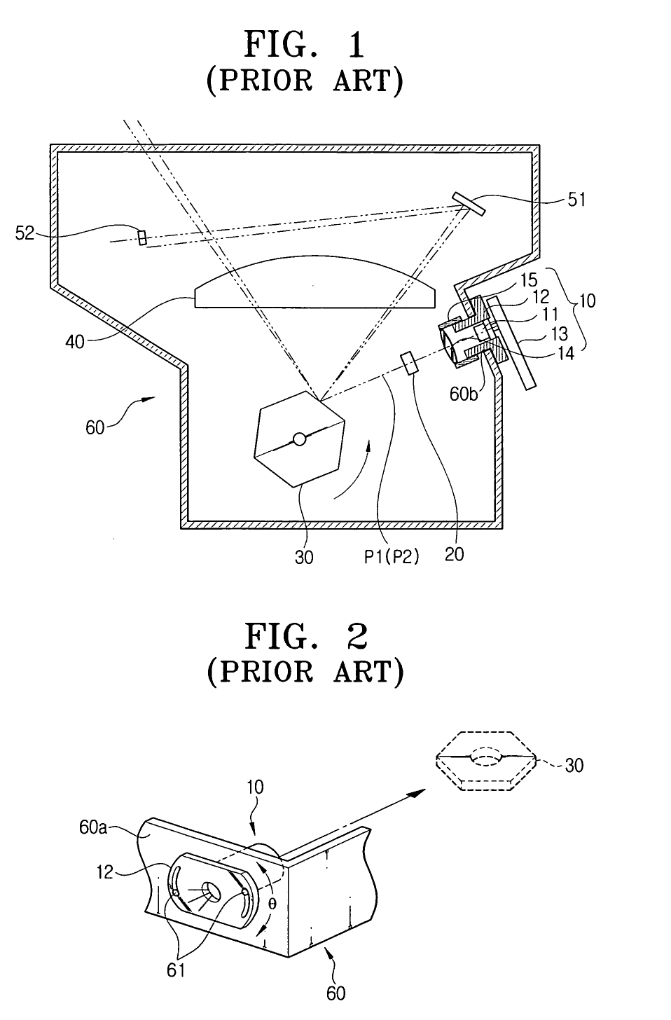

### DETAILED DESCRIPTION OF THE PREFERRED EMBODIMENTS

Hereinafter, various embodiments of the present invention will be described in detail with reference to the accompanying drawing figures.

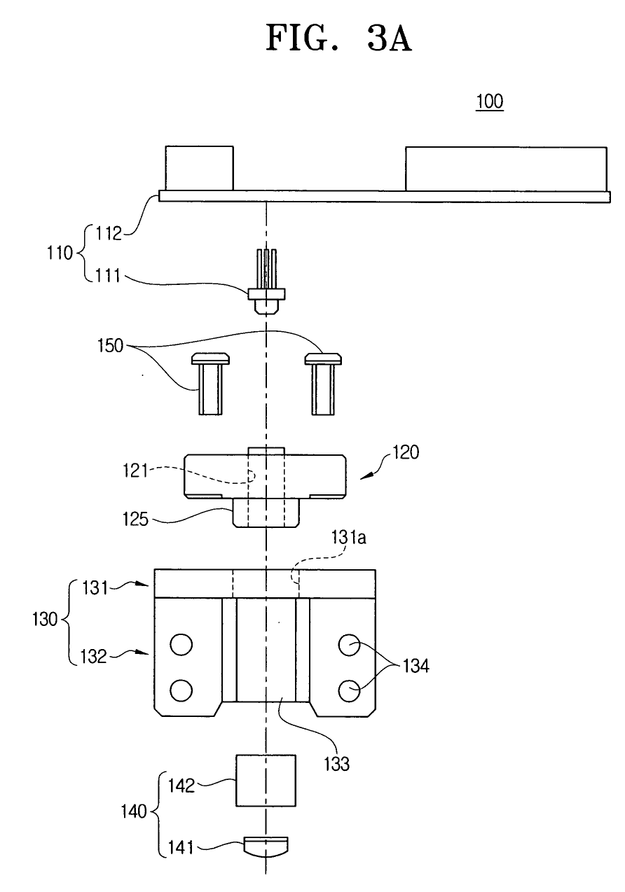

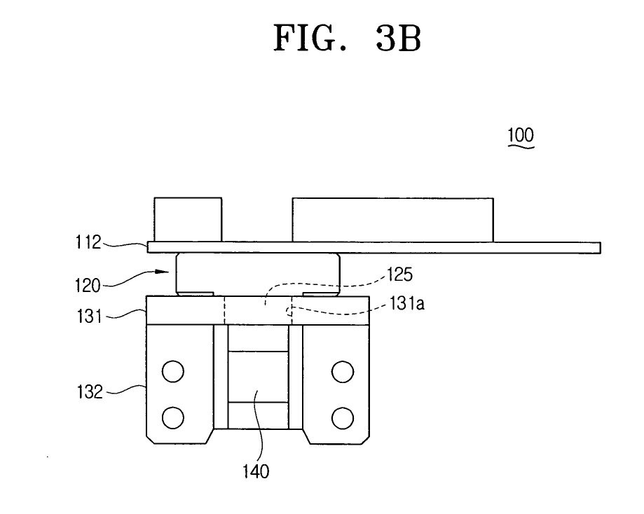

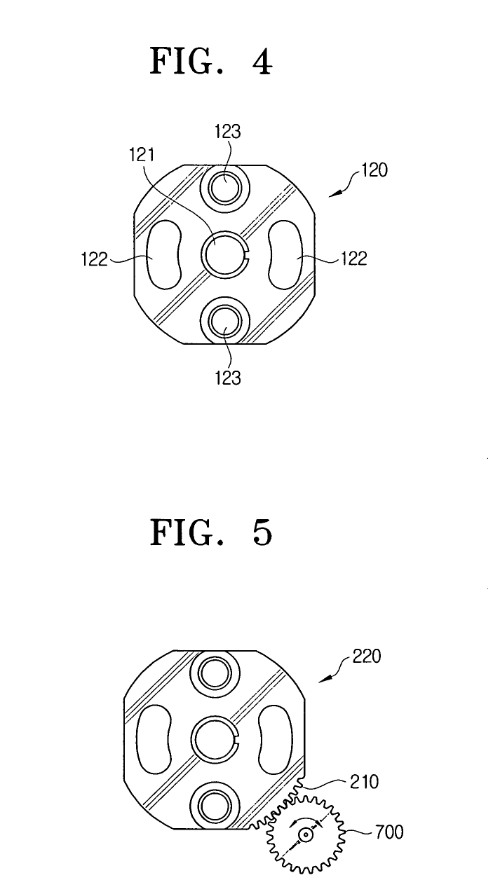

As shown in FIGS. 3A, 3B and 4, according to an embodiment of the present invention, the multibeam light source unit 100 includes a diode unit 110, a rotating member 120, a fixing member 130 and a collimating lens assembly 140.

The diode unit 110 has a multibeam semiconductor laser diode 111 for emitting a plurality of laser beams P1 and P2 (see FIG. 8) and a driving circuit board 112 for controlling the driving of the laser diode 111.

The rotating member 120 supports the laser diode 111 and the driving circuit board 112 and can rotate on the fixing member 130. A press fit hole 121 into which the laser diode 111 is inserted and fixed is formed at the center of the rotating member 120. The rotating member 120 has a pair of arc-shaped long holes 122 (FIG. 4) at the left and right sides on its top surface and a pair of circular holes 123 at the upper and lower sides on its top surface.

Fastening means (not shown), such as screws, for connecting the driving circuit board 112 to the rotating member 120 are engaged into the circular holes 123. Screws 150 are engaged into the arc-shaped long holes 122 to connect the rotating member 120 to the fixing member 130. The long holes 122 enable the rotating member 120 to turn in a forward or backward direction on the fixing member 130 when the screws 150 are slightly released.

The rotating member 120 also has a rotating boss 125 which can be its center of rotation. The rotating boss 125 is projected by a predetermined height from the surface of the rotating member 120 that faces the fixing member 130.

The fixing member 130 rotatably supports the rotating member 120. The fixing member 130 includes a first member 131 having a boss hole 131 a into which the rotating boss 125 is rotatably inserted and a second member 132 vertically extending from the first member 131. Although not shown in the drawing figures, the first member 131 has holes corresponding to the circular holes 123 of the rotating member 120. The second member 132 has, at its center, a semi-circular groove 133 in which the collimating lens assembly 40 is placed. A plurality of holes 134 are formed at both sides of the semi-circular groove 133 so that the second member 132 can be fixed to a frame 600 (see FIG. 8) by fastening means, such as screws.

The collimating lens assembly 140 includes a collimating lens 141 and a barrel-shaped lens holder 142 for supporting the lens 141. The collimating lens assembly 140 is placed within the semi-circular groove 133 formed on the second member 132 of the fixing member 130. The collimating lens assembly 140 transforms multiple laser beams emitted from the multibeam laser diode 111 into parallel rays of light.

In the multibeam light source unit 100 according to the certain embodiment of the present invention, the multibeam laser diode 111 is press-fitted into the press fit hole 121, and the driving circuit board 112 is fixed to the opposite side of the rotating boss 125 of the rotating member 120. The collimating lens assembly 140 is placed within the fixing member 130.

The rotating member 120 is provisionally connected to the fixing member 130 by engaging the screws 150 into the arc-shaped long holes 122 of the rotating member 120, with the rotating boss 125 of the rotating member 120 being inserted into the boss hole 131 a of the fixing member 130.

In the condition of provisional connection, the rotating member 120 is turned on the fixing member 130 at a predetermined angle using a laser beam position alignment jig in order to align the positions of multiple laser beams.

After the completion of the laser beam position alignment, the screws 150 are tightly fastened to fix the rotating member 120 to the fixing member 130, thus completing the assembly of the multibeam light source unit 100.

As shown in FIG. 8, the assembled multibeam light source unit 100 is moved to the main assembly line for assembling a laser scanning apparatus. The multibeam light source unit 100 is mounted onto the bottom 610 of the frame 600.

In the prior art, the position alignment of laser beams is performed in the main assembly line when an assembled multibeam light source unit is fixed to a side wall of the frame to complete the assembly of a laser scanning apparatus. Thus, a large laser beam position alignment jig is needed in the main assembly line. According to the certain embodiment of the present invention, the position alignment of laser beams is performed in a sub-assembly line for assembling the multibeam light source unit 100. The laser beam position alignment is performed during the assembly of the multibeam light source unit 100. Since the assembled multibeam light source unit 100 is simply mounted onto the bottom 610 of the frame 600 in the main assembly line, it is not required to provide a large laser beam position alignment jig in the main assembly line, which simplifies and minimizes the facility for assembling a laser scanning apparatus.

FIG. 5 is a plan view illustrating another example of a rotating member that is part of the multibeam light source unit according to the certain embodiment of the present invention. . As shown in FIG. 5, rotating member 220 is different from the rotating member 120 only in that it has a gear section 210 at one side of the periphery thereof. The gear section 210 is provided to more easily turn the rotating member to a predetermined angle. The gear section 210 is engaged with a rotary gear 700 of a laser beam position alignment jig. When the rotary gear 700 rotates, the rotating member 700 turns together with the laser diode to align the positions of the laser beams. The gear section 210 can be a spiral gear, a helical gear, a worm gear or any other shape gear.

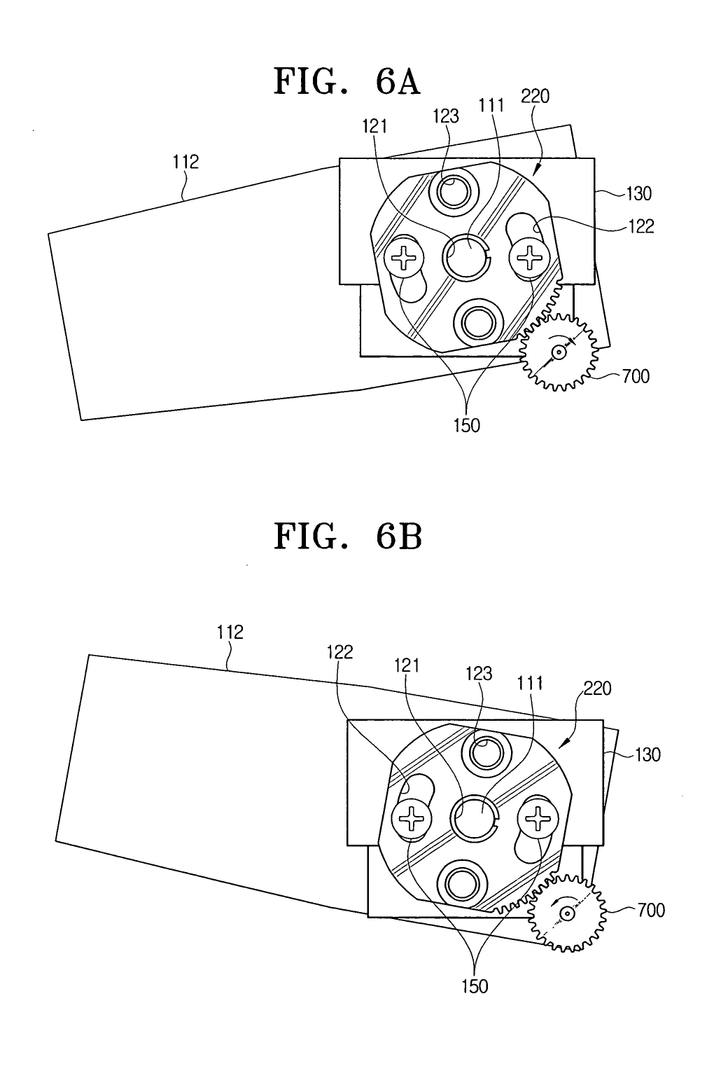

FIGS. 6A and 6B illustrate the position alignment of laser beams performed by turning the multibeam light source unit 100 having the rotating member 220 in a forward or backward direction using a laser beam position alignment jig. As shown in FIGS. 6A and 6B, the multibeam light source unit 100 is set on the laser beam position alignment jig such that the gear section 210 of the rotating member 220 is engaged with the rotary gear 700. Referring to FIG. 6A, when the rotary gear 700 rotates clockwise, the rotating member 220 turns in the counter-clockwise direction. Since the laser diode 111 and the driving circuit board 112 are combined with the rotating member 220, the laser diode 111 also turns at a predetermined angle and achieves position alignment of its laser beams. The fixing member 130 fixed to the laser beam position alignment jig does not move at this time. FIG. 6B illustrates the rotating member 220 that has been turned clockwise by rotation of the rotary gear 700 in the counter-clockwise direction.

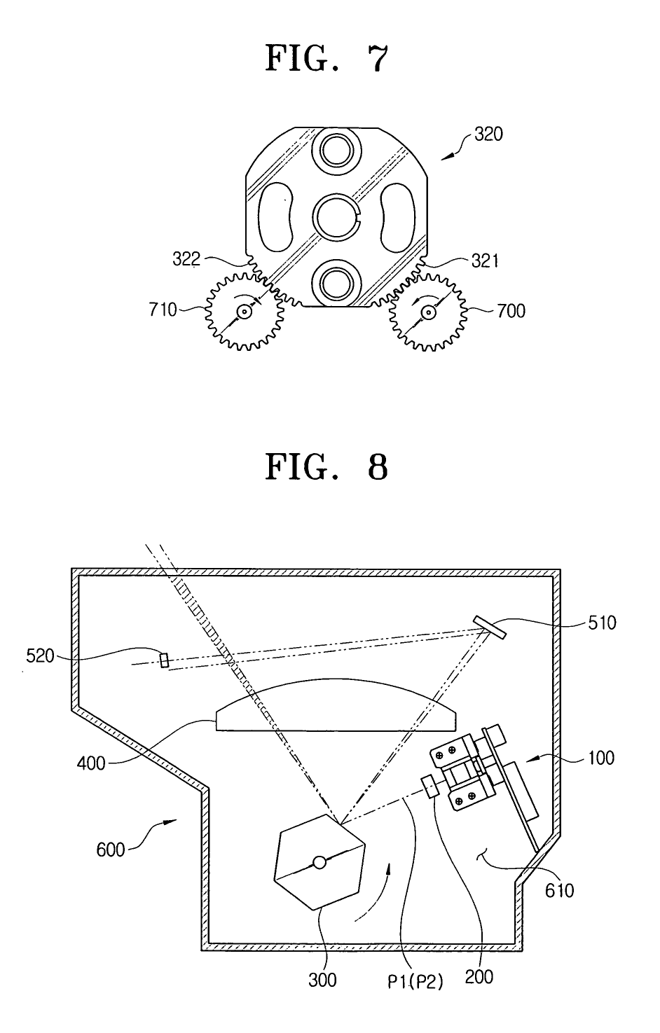

FIG. 7 is a plan view illustrating still another example of a rotating member that is part of the multibeam light source unit according to the certain embodiment of the present invention. As shown in FIG. 7, a rotating member 320 is different from the rotating member 220 in that it has two opposing gear sections 321 and 322 at two sides of the periphery thereof. In this example, the gear sections 321 and 322 of the rotating member 320 are engaged with rotary gears 700 and 710 provided in a laser beam position alignment jig. The two rotary gears can prevent unstable turning caused by a gear backlash and accurately control the turning angle of the rotating member 320.

FIG. 8 is a plan view illustrating an example of a laser scanning apparatus having the multibeam light source unit according to the certain embodiment of the present invention.

As shown in FIG. 8, the multibeam light source unit 100 is readily fixed onto the bottom 610 of the frame 600 by use of fastening means, such as a screw. Since the multibeam light source unit 100 is transferred to the main assembly line from the sub-assembly line after the completion of the laser beam position alignment, a laser scanning apparatus can be more efficiently assembled in the main assembly line.

In addition, a cylindrical lens 200, a polygon mirror 300 and an image resulting lens 400 which form a scanning/image resulting unit, and a detection mirror 510 and an optical sensor 520 which form a synchronizing signal detection unit are placed in proper positions of the bottom 610 of the frame 600.

A plurality of laser beams P1 and P2 emitted from the multibeam light source unit 100 are linearly concentrated onto the reflection plane of the polygon mirror 300 by the cylindrical lens 200, and then scanned by the polygon mirror 300. The laser beams are then led to the surface of a photoreceptor of a rotating drum (not shown) by way of the image resulting lens 400 to form an image.

The process of exposure by the laser scanning apparatus according to the certain embodiment of the present invention is the same as the conventional process. The laser scanning apparatus according to the certain embodiment of the present invention is assembled, however, through the above-described method of mounting the multibeam light source unit 100 onto the frame in the main assembly line after completing the laser beam position alignment in the sub-assembly line.

As described above, the certain embodiment of the present invention can easily and accurately align the positions of multiple laser beams in the sub-assembly line for assembling a multibeam light source unit.

Since a large jig for laser beam position alignment is not required in the main assembly line for assembling a laser scanning apparatus, the facility for the main assembly line can be simplified and minimized.

Consequently, the present invention can improve workability and productivity of the manufacturing facility.

Although certain embodiments have been described for illustrative purposes, the present invention is not to be unduly limited to the configuration or operation set forth herein. Those skilled in the art will appreciate that various modifications, additions and substitutions are possible, without departing from the scope and spirit of the invention as disclosed in the accompanying claims.

1. A multibeam light source unit comprising:
a diode unit including a laser diode for emitting a plurality of laser beams;
a rotating member for supporting the laser diode; and
a fixing member for rotatably supporting the rotating member,
wherein said rotating member is turned at an angle selected to align the positions of the plurality of laser beams and is then fixed to the fixing member.

2. The multibeam light source unit according to claim 1, wherein:
said rotating member comprises a press fit hole into which the laser diode is press-fitted and a rotating boss as a center of rotation; and
said fixing member comprises a first member having a boss hole into which the rotating boss is rotatably inserted and a second member vertically extending from the first member.

3. The multibeam light source unit according to claim 2, wherein:
a pair of screws are provided to fix the rotating member which has been turned and adjusted to the first member of the fixing member; and
said rotating member further comprises a pair of circular arc-shaped long holes into which said pair of screws can be engaged.

4. The multibeam light source unit according to claim 2, wherein said rotating member further comprises a gear section at one side to be engaged with a rotary gear of a laser beam position alignment jig for turning the rotating member.

5. The multibeam light source unit according to claim 4, wherein said rotating member further comprises another gear section at the opposite side of said gear section, said other gear section being engaged with another rotary gear of the laser beam position alignment jig.

6. The multibeam light source unit according to claim 2, wherein said diode unit comprises a driving circuit board for controlling the driving of the laser diode, said driving circuit board being connected to the rotating member.

7. The multibeam light source unit according to claim 2, further comprising:
a collimating lens for transforming a plurality of laser beams emitted from the laser diode into parallel rays of light; and
a lens holder for supporting the collimating lens, said lens holder being placed within the second member of the fixing member.

8. The multibeam light source unit according to claim 7, wherein said second member comprises a semi-circular groove for receiving the lens holder at the center thereof, and a plurality of holes at both sides of the semi-circular groove so that the second member can be fixed to an object by use of any fastening means penetrating the holes.

9. A laser scanning apparatus comprising:
a multibeam light source unit for emitting a plurality of laser beams;
a scanning/image resulting unit for scanning a plurality of laser beams and forming an image on the scanning plane; and
a frame for supporting the multibeam light source unit and the scanning/image resulting unit,
said multibeam light source unit comprising:
a laser diode having at least two laser beam projecting sections;
a driving circuit board for controlling the driving of the laser diode;
a rotating member for supporting the laser diode and the driving circuit board; and
a fixing member for rotatably supporting the rotating member,
wherein said rotating member is turned at a predetermined angle to align the positions of the two laser beams and is then fixed to the fixing member.

10. The laser scanning apparatus according to claim 9, wherein said light source unit is mounted and fixed onto the bottom of the frame.

11. The laser scanning apparatus according to claim 9, wherein said scanning/image resulting unit comprises:
a polygon mirror for scanning the plurality of laser beams projected from the multibeam light source unit; and
an image resulting lens for imaging the laser beams scanned by the polygon mirror on the scanning plane, and wherein
said laser scanning apparatus comprises:
a cylindrical lens for linearly concentrating the plurality of laser beams onto the reflection plane of the polygon mirror; and
a synchronizing signal detection unit.

12. The laser scanning apparatus according to claim 9, wherein:
said rotating member comprises a press fit hole into which the laser diode is press-fitted and a rotating boss as a center of rotation;
said fixing member comprises a first member having a boss hole into which the rotating boss is rotatably inserted and a second member vertically extending from the first member; and
said second member of the fixing member of the multibeam light source unit is fixed onto the bottom of the frame by a plurality of fastening means.

13. The laser scanning apparatus according to claim 12, wherein said multibeam light source unit further comprises a collimating lens for transforming a plurality of laser beams emitted from the laser diode into parallel rays of light; and
a lens holder for supporting the collimating lens, said lens holder being placed within the second member of the fixing member.

14. The laser scanning apparatus according to claim 13, wherein said second member comprises:
a semi-circular groove for receiving the lens holder at the center thereof and a plurality of holes at both sides of the semi-circular groove so that the second member can be fixed to an object by use of any fastening means penetrating the holes.

15. A method for fabricating a multibeam laser scanning apparatus, comprising
assembling a multibeam light source unit comprising a laser diode for emitting a plurality of laser beams in a sub-assembly line; and
mounting the multibeam light source unit into a frame in a main assembly line,
wherein said step of assembling the multibeam light source unit in the sub-assembly line includes turning the laser diode at a predetermined angle to align the positions of the plurality of laser beams emitted from the laser diode.

16. The method according to claim 15, wherein said multibeam light source unit comprises a rotating member for supporting the laser diode and a fixing member for rotatably supporting the rotating member, said rotating member being turned at a predetermined angle to align the position of the laser diode, with the fixing member being fixed to the alignment jig.

17. The method according to claim 16, wherein said rotating member comprises a gear section formed at one side of the periphery thereof and is turned at a predetermined angle using a laser beam position alignment jig which has a fixing section for fixing the fixing member of the multibeam light source unit and a rotary gear engaged with a gear section of the rotating member.
